(19) United States
(12) Patent Application Publication
(10) Pub. No.: US 2007/0296131 A1
(43) Pub. Date: Dec. 27, 2007

(54) IMPACT DAMPER

(75) Inventors: Hubert SIEMER, Dinklage (DE); Stefan LOHEIDE, Wallenhorst (DE); Josef BURWINKEL, Dinklage (DE)

Correspondence Address: NORRIS, MCLAUGHLIN & MARCUS, 875 THIRD AVE, 18TH FLOOR, NEW YORK, NY, 10022, US

(73) Assignee: ZF FRIEDRICHSHAFEN AG, Friedrichshafen (DE)

(21) Appl. No.: 11/760,339

(22) Filed: Jun. 8, 2007

(30) Foreign Application Priority Data
Jun. 21, 2006 (DE) 10 2006 028 879.3

(51) Int. Cl. F16F 15/06; B60G 15/06

(52) U.S. Cl. 267/292

(57) ABSTRACT

An impact damper (7) with at least one damper unit (8, 9, 10, 11). The damper unit (8, 9, 10, 11) includes at least one elastomer spring element (15), at least one fluid-filled primary chamber (24), and at least one fluid-filled secondary chamber (27), as well as one nozzle opening (26) connecting the two chambers (24, 27), wherein the fluid can be displaced during spring deflection of the elastomer spring element (15) from the primary chamber (24) into the secondary chamber (27). The impact damper (7) includes a damper unit (8, 9, 10, 11) has the shape of a rotational toroidal or an annular body. The impact damper of the invention is suitable, in particular, for high-end damping applications, for example the wheel suspension of automobiles, and more particularly for overcoming such divergent requirements as an early force buildup, a uniform energy dissipation with a long stroke, and a high energy absorption. The impact damper reduces the repair frequency of connecting elements which may become necessary, for example, when excess stress is applied to the chassis; or optionally, the weight and the costs of the connecting components can be reduced.

### BACKGROUND OF THE INVENTION

1. Field of the Invention

The invention relates to an impact damper, in particular for use in an automobile, according to the preamble of claim 1.

2. Description of the Related Art

Impact dampers are used in different areas of mechanical engineering for absorbing or dissipating energy at the end of the relative movement of components and assemblies. To this end, less demanding applications employ, for example, parabolic rubber springs or substantially cylindrical stop springs made of damping materials, for example of polyurethane elastomers.

However, these conventional elastomer stop springs are mostly limited to applications requiring effective protection against direct metal-to metal contact, without the need for effectively and uniformly dissipating large amounts of kinetic energy. Other types of elastomer vibration dampers with hydraulic support (so-called hydro-springs and the like) are also known in the art, but these cannot be used in axle supports, in particular not with McPherson struts, due to their constructive and geometric limitations.

In certain applications, for example, in automobiles, in particular for wheel suspension or on struts of vehicle axles, conventional stop springs increasingly reach their design limits. Conventional stop springs on vehicle axles and struts are used to minimize or even prevent damage to the wheel suspension and chassis of the automobile when the wheel spring bottoms out, for example when the vehicle is accidentally driven through a pothole or run over a curb at high speed.

In general, conventional McPherson strut assemblies mounted on the automobile transmit forces, which are exerted by the road surface on the wheel, to the car body by way of the support spring, the damper and optionally the stop spring. The transmitted forces can under misusage, for example, when the car is driven over an obstacle, attain very high values, so that the car body can be deformed in the region where the strut is mounted. This can in turn require repairs on the vehicle associated with substantial consequential costs.

These problems led to the development of so-called high impact dampers (HID) capable of absorbing peak forces that may be generated in the strut at high spring deflection velocities of, for example, greater than 3 m/s, and reducing these peak forces to a lower force level. However, peak forces generated by the impact of the strut on the stop spring following the spring defection of the damper are not reduced or at least not to the same degree. This is due to the fact that conventional stop springs are designed with a very progressive spring characteristic, which produces a very small damping effect and also a short spring deflection. The peak forces generated at the stop springs can therefore be significantly greater than the peak forces at the damper, which can cause the aforementioned deformation or damage, in particular in the region of the wheel housing and the strut domes.

### SUMMARY OF THE INVENTION

It is therefore an object of the present invention to produce an alternative solution to conventional stop springs—in particular for applications in wheel suspension for automobiles—and to overcome the aforementioned disadvantages of the prior art. More particularly, the invention should effectively reduce those peak forces that are produced following the spring deflection of the support spring or the wheel damper if, for example, a strut bottoms out.

Because uniform energy dissipation is desirable, the invention should help prevent expensive repairs of connecting elements of automobiles, which may occur under misusage or when the springs bottom out. On the other hand, the invention should also allow a designer to reduce the dimensions, cost and weight of the corresponding connecting elements due to the smaller impact forces to be absorbed.

The object is solved by an impact damper having the features of claim 1.

Preferred embodiments are recited in the dependent claims.

The impact damper according to the present invention includes in an essentially conventional manner a damper unit with an elastomer spring element, a fluid-filled primary chamber, and a fluid filled secondary chamber, wherein the primary chamber and the secondary chamber are connected with one another by a nozzle opening. During spring deflection of the impact damper or the elastomer spring element, the fluid is displaced from the primary chamber into the secondary chamber.

However, the impact damper according to the invention is different in that the damper unit of the impact damper has the form of a rotational toroidal body or annular body, respectively. A rotational toroidal bodily or annular body is characterized by an opening extending through the rotational body along its symmetry axis of rotation, whereby the cross-sectional shape can initially be arbitrary. The impact damper according to the invention can then include other components that extend through its opening.

Unlike conventional stop springs formed as, for example, parabolic springs or conventional hydro-springs, which absorb applied forces essentially as a point load, the impact damper according to the invention advantageously absorbs forces along an annular contact surface. According to the invention, other machine elements, such as the piston rod of a shock absorber on an automobile strut, can extend through the central opening of the annular or toroidal impact damper.

Unlike other types of impact dampers which are also made of an elastomer material or polyurethane foam and are shaped as an annular body or hollow cylinder, the impact damper according to the invention is much better suited to uniformly and more efficiently dissipate energy. Stated differently, unlike conventional elastomer dampers, the impact damper according to the invention provides from the beginning comparatively high reaction forces at high impact velocities, thereby effectively preventing buildup of extreme peak forces at the end of the impact.

The impact damper according to the invention therefore combines the advantages of hydraulically supported, essentially punctiform impact dampers with fluid-filled damping chambers with the advantages of annular impact dampers made of a solid elastomer material or an elastomer foam. The impact damper according to the invention therefore makes it possible for the first time to employ such combined impact element, which at the same time is a spring and a highly effective damper, in the area of the wheel suspension and more particularly in struts of automobiles.

The invention may initially be implemented regardless of how the fluid chambers of the impact damper according to the invention are shaped and arranged. For example, the impact damper of the invention may be designed to have only a single primary chamber which extends substantially in a toroidal or annular form along the entire circumference of the impact damper.

According to a preferred embodiment of the invention, the damper unit of the impact damper includes a plurality of primary chambers. The primary chambers within of the annular damper unit are arranged substantially along a circle. This embodiment produces a very robust impact damper that can be easily manufactured. This design also effectively prevents a potentially undesirable overflow of the fluid in the circumferential direction during spring deflection of the impact dampers.

According to another preferred embodiment of the invention, the at least one primary chamber or the primary chambers is/are each formed essentially by an elastomer spring element. Stated differently, the elastomer spring element of the impact damper is shaped so as to simultaneously form the essential portion of the cavity or cavities representing the primary chambers. This embodiment of the invention enables a simple design of the primary chambers, whereby the elastomer spring element advantageously has a dual use also as a fluid chamber.

Preferably, several or all primary chambers of the damper unit are formed by the same primary chamber component that also forms the elastomer spring element. In other words, a one-piece elastomer component already forms or includes several or even all the primary chambers. This embodiment can be produced and installed cost-effectively, and is also robust and reliable when used as impact damper.

Initially, the total number, the design and the association of the secondary chambers is arbitrary, as long as the fluid exiting from each of the existing primary chambers is collected in a secondary chamber during spring deflection. For example, each existing primary chamber may have a dedicated secondary chamber. However, according to another preferred embodiment of the invention, a single secondary chamber may be associated with several or with all primary chambers of the damper unit. Stated differently, during the spring deflection of the impact damper, the fluid from several or even all the primary chambers of the damper unit may be displaced through the respective nozzle openings into a single secondary chamber common to the primary chambers. With this embodiment of the invention, the number of required components can be further reduced, thus simplifying the design and facilitating installation of the impact damper.

The shape and design of the nozzle openings of the impact damper is not essential for implementing the invention. For example, a dedicated nozzle plate with nozzle opening may be provided for each primary chamber of the damper unit. However, according to a preferred embodiment of the invention, all nozzle openings of the damper unit may be arranged in a single nozzle plate, wherein the nozzle plate may be formed as a substantially annular perforated component, for example, made of sheet metal. With this embodiment, all the nozzle openings can be implemented with the simple, robust and cost-effective nozzle plate which may preferably be fabricated in one piece.

According to another particularly preferred embodiment of the invention, a jet dispersing element, preferably formed by a baffle plate, may be arranged in the region behind each nozzle opening between a nozzle plate or nozzle opening and the secondary chamber. The jet dispersing element or baffle plate may be used for dispersing or swirling the fluid jet which, for a high load on the impact damper, exits from the nozzle opening and enters the secondary chamber with a high velocity. This approach effectively prevents a narrow laminar fluid jet from damaging the elastomer component which forms, for example, the secondary chamber. The dispersing element and/or the baffle plate also increases the efficiency of the impact damper by efficiently converting kinetic energy into heat during the dispersion or swirling process.

According to another preferred embodiment of the invention, the housing of the damper unit may be formed by a one-piece annular body having an open cross-sectional shape. Preferably, the housing may be pressed or rolled with the primary chamber component, the nozzle plate and the secondary chamber component. The housing of the damper unit may be formed as a one-piece annular body with an open cross-section, since a housing shaped in this way can advantageously be manufactured cost-effectively and be made very stiff, for example by deep drawing.

The housing may be connected with the primary chamber component, nozzle plate and secondary chamber component by pressing or rolling, which represents a simple, quick and cost-effective installation step and produces a secure connection between the components of the damper unit and also a reliable and reproducible seal between primary chamber, secondary chamber and housing. Advantageously, no other joining materials, sealing materials and connecting elements are required for assembling the damper unit.

According to another, alternative embodiment of the invention, the housing may be made of a polymer material and may be materially connected with at least one of connecting components primary chamber component, nozzle plate and secondary chamber component. This embodiment is particularly advantageous because a housing made of a polymer material offers more design choices, lower costs and less weight. The material connection between such housing made of polymer material and the associated connecting components, in particular the primary chamber component, for example by gluing, friction welding or ultrasonic welding, provides additional advantages, in particular with respect to cost-effective manufacturing with short cycle times.

According to another preferred embodiment of the invention, the primary chamber component may have support rings which are preferably made of plastic or metal and are vulcanized to or within the primary chamber component. In this way, the permissible spring deflection of the impact damper can be increased significantly, which due to the stiff enclosure of the fluid in the primary chamber, uniformly and reliably dissipates energy by way of the fluid and the nozzle plate without time delays even at high spring deflection velocities.

According to another embodiment of the invention, the primary chamber component may have in the region of an end face of the impact damper a substantially annular connecting element that may be vulcanized to or within the end face. This approach enables a simple and reliable connection between the impact damper and adjacent components, for example, when suitable connecting elements, such as screws, pins or rivets are inserted into the connecting element.

According to another preferred embodiment of the invention, when the impact damper of the invention is used on an automobile, in particular in the area of the wheel suspension or the struts, the impact damper may include at least two damper units connected in series. Each of the serially connected damper units has a primary chamber, a secondary chamber, a nozzle plate, and a housing. The spring deflection of the impact damper and hence also its ability to dissipate energy, can thereby be increased, possibly by an order of magnitude or more, while still keeping the impact forces small and uniform during almost the entire spring deflection. An impact damper according to this embodiment is therefore well suited for use on the chassis and for absorbing peak loads, which may occur particularly when the chassis springs bottom out.

According to another embodiment, the housings of two serially adjacent damper units may be configured as a single unit, which also saves costs and space and reduces weight. Preferably, corresponding pairs of damper units may be arranged or connected anti-parallel with respect to one another. An anti-parallel arrangement allows a constructively simple connection due to the mirror-symmetric arrangement of the damper units; in addition, using identical parts is very cost-effective.

According to another preferred embodiment of the invention, the impact damper may be a McPherson strut impact damper, wherein the piston of the shock absorber of the strut may be annularly surrounded by the impact damper. In this way, the conventional impact dampers, for example impact dampers made of an elastomer or polyurethane foam, can be replaced by the impact damper of the invention without requiring significant modifications in the design of the strut or the strut domes.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

In the drawings, wherein like reference numerals delineate similar elements throughout the several views:

FIG. 1 shows schematically in a cross-sectional view an embodiment of an impact damper according to present invention installed with a vehicle strut;

FIG. 2 is a schematic diagram of a vehicle strut;

FIG. 3 shows on an enlarged scale, as compared to FIG. 1, a diagram of another embodiment of an impact damper according to the invention;

FIG. 4 in an isometric, partially cut view the impact damper of FIG. 3 installed in a vehicle strut; and

FIG. 5 shows an enlarged detailed view of the impact damper according to FIGS. 3 and 4.

### DETAILED DESCRIPTION OF THE PRESENTLY PREFERRED EMBODIMENTS

FIG. 1 shows schematically in a longitudinal cross-sectional view the upper end section of, for example, a McPherson strut of an automobile, with a schematically indicated strut support spring 1, further with an upper end of a piston rod 2 of the strut shock absorber, and a dome plate unit 3 used for connecting the strut to the apex (not shown) of the wheel housing of the automobile. To allow steering, the support spring 1 is rotatably supported on the dome plate unit 3 by a support plate 4 and an axial ball bearing 5. The piston rod 2 of the shock absorber is supported via an elastomer bearing 6 against the dome plate unit 3.

FIG. 1 also shows an embodiment of the impact damper 7 according to the invention with its upper end face supported directly on the dome plate unit 3. The impact damper 7 shown in FIG. 1 includes four serially connected damper units 8, 9, 10, 11, wherein each of the four damper units 8, 9, 10, 11 has its own spring elements, primary chambers, secondary chambers and nozzle plates.

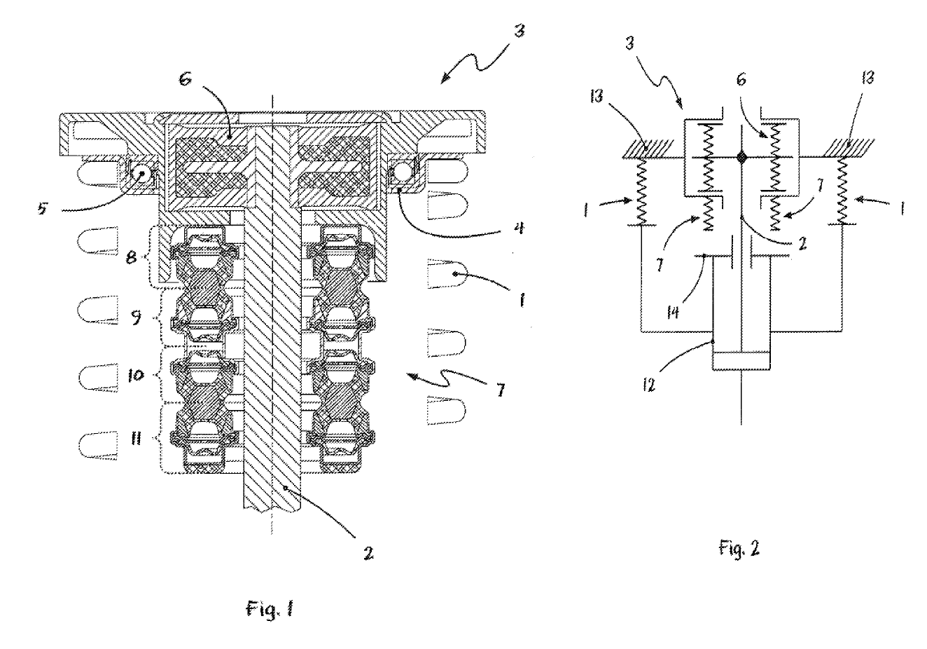

FIG. 2 shows a schematic high-level diagram of a vehicle strut which is substantially identical to that of FIG. 1. However, unlike FIG. 1, FIG. 2 shows not only the upper end of the strut, but essentially the entire strut, including the support spring 1 and shock absorber 12. Also shown is the cylinder of the shock absorber 12, which is connected with the lower end of the support spring 1. As also depicted in FIG. 1, the upper end of the support spring 1 contacts the dome plate unit 3, which is connected at 13 with the vehicle chassis. The upper end of the piston rod 2 of the shock absorber 12 is elastically received in the dome plate unit 3 by the elastomer support 6.

The impact damper 7 is representatively indicated in FIG. 2 by the springs 7. Accordingly, an impact plate 14 connected with the shock absorber cylinder 12 strikes the impact damper 7 when the strut bottoms out, thereby reducing the peak forces produced at impact to values small enough to be sustained by the chassis.

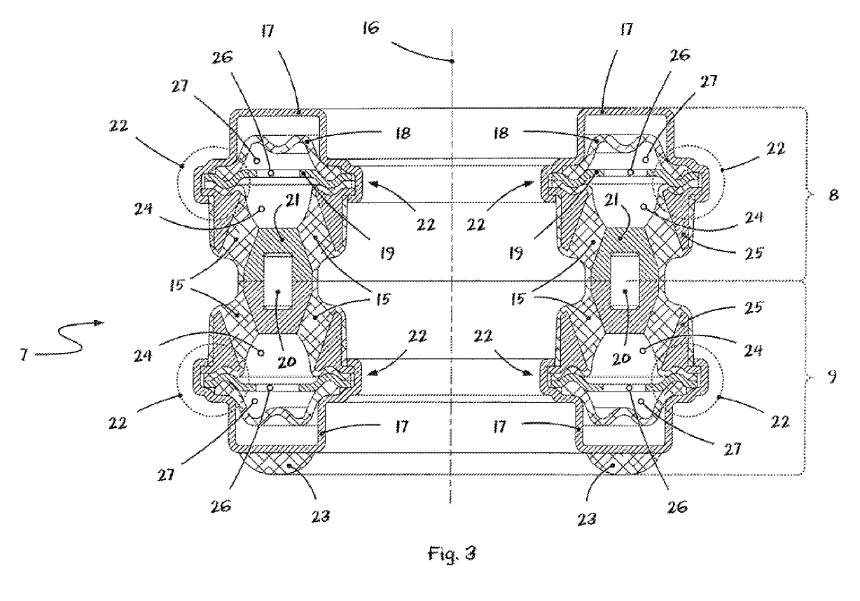

FIG. 3 shows on an enlarged scale compared to FIG. 1 another embodiment of an impact damper of the invention, which is basically identical to the impact damper shown in FIG. 1. The major difference between the impact dampers of FIG. 3 and FIG. 1 is that the impact damper of FIG. 1 has four serially connected damper units 8, 9, 10, 11, whereas the impact damper of FIG. 3 has only two serially connected damper units 8, 9.

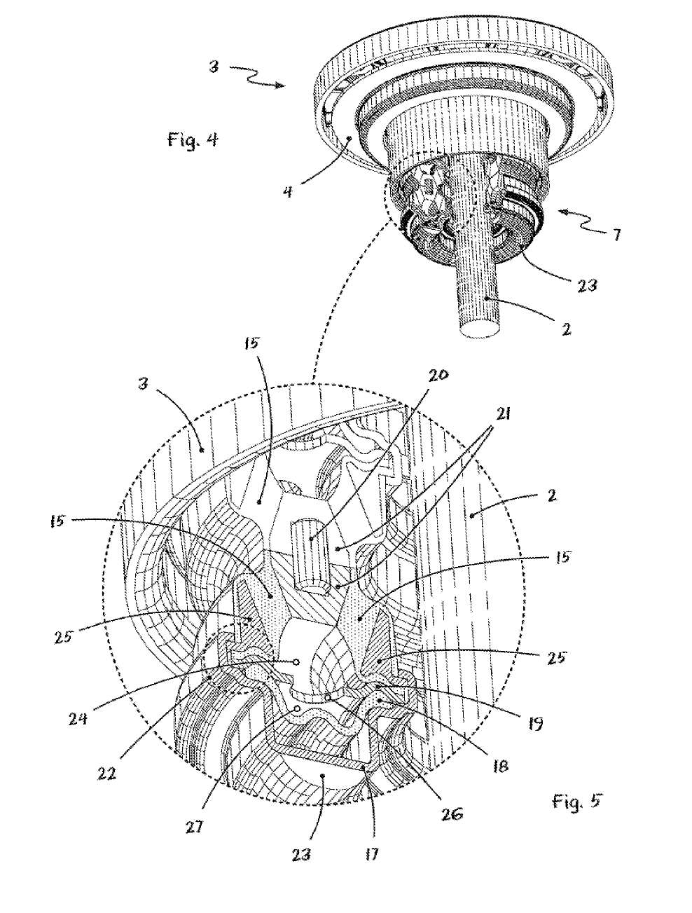

The annular or toroidal shape of the impact damper 7 or of the individual damper units 8, 9 of the impact damper 7 according to the invention can be more clearly visualized when viewing FIG. 3 together with FIGS. 4 and 5, which show in an isometric view the same impact damper 7 of FIG. 3 after installation.

In other words, the elastomer spring elements 15 of the each damper unit 8, 9 extend substantially circularly about the symmetry axis 16 of the impact damper 7. In addition, the corresponding housing 17, the secondary chamber 27 formed by the corresponding elastic secondary chamber component 18 and the associated nozzle plate 19, and the corresponding connecting element 21 also extend circularly about the symmetry axis 16 of the impact damper 7.

The two damper units 8, 9 of the impact damper 7 according to FIGS. 3 to 5 are connected with one another by dowel pins which are arranged in the corresponding bores of the connecting element 21 of the two damper units 8, 9. FIG. 3 also shows the connection of the components elastomer spring 15, nozzle plate 19, secondary chamber component 18 and housing 17 which in the illustrated embodiment are effectively connected at 22 by rolling the edges of the housing 17 around the corresponding edges of elastomer spring 15, the nozzle plate 19 and the secondary chamber component 18. Additional joining or sealing materials, or other additional connecting elements are not required. The damper unit pairs 8, 9 and 10, 11 formed of the damper units 8 and 9, and 10 and 11, respectively, in the impact damper 7 according to FIG. 1, which unlike the impact damper 7 illustrated in FIGS. 3 to 5 includes not two, but four damper units, are connected with an annular housing component that is common to the damper unit pairs 8, 9 and 10, 11, thereby further reducing the number of components of the impact damper.

FIG. 3 also illustrates an elastomer support 23 which, as referenced to the drawing, is arranged on the bottom side of impact damper 7. When the wheel spring bottoms out, the elastomer support 23 transmits a uniform force from the impact plate 14 of the strut (see FIG. 2) to the impact damper 7.

FIG. 4 and FIG. 5 show once more the impact damper 7 according to FIG. 3 in an isometric and partially cut view, wherein FIG. 5 depicts an enlarged detail of FIG. 4. Clearly shown is the annular or toroidal shape of the impact damper 7 according to the invention, which allows the impact damper 7 to be arranged, for example, circularly around the piston rod 2 of the shock absorber 12 (not shown) of a strut.

The design of the primary chambers 24 of the damper units 8, 9 of the impact a damper is illustrated more particularly in FIG. 5. As can be seen, the elastomer spring 15 of each damper unit 8, 9 is provided with integrally vulcanized, for example metallic, ring elements 25 which also securely clamp the elastomer spring 15 in the region of the shoulder or rolled-up portion 22 of the housing 17 of the damper unit 8, 9. With the integrally vulcanized ring elements 25, the primary chambers 24 formed by the elastomer springs 15 of the damper units 8, 9 reliably displace the enclosed fluid volume without delay through the nozzle openings 26 disposed in the nozzle plate 19 into the secondary chamber 27, without adversely distending the primary chambers 24 due to the potentially high interior pressure in the primary chambers 24, thereby delaying energy dissipation.

In the embodiment depicted in FIGS. 3 to 5, each damper unit 8, 9 has a plurality of primary chambers 24 which are, however, all formed by the elastomer spring 15 of the damper unit 8, 9 as a single piece. Alternatively, the primary chambers 24 of a damper unit 8, 9 may, for example, also be connected in the peripheral directions of the damper unit 8, 9, or only a single, substantially toroidal primary chamber 24 may be provided.

As shown in FIGS. 3 to 5, a nozzle opening 26 in the nozzle plate 19 is associated with each of the primary chambers 24 of a damper unit 8, 9 of the impact dampers 7, as illustrated more particularly in FIG. 5. The spring deflections of the impact damper 7 displace the fluid in the primary chamber 24 through the nozzle opening 26 into the secondary chamber 27. The energy transmitted to the impact damper 7 during spring deflection is damped or dissipated depending on the diameter of the nozzle opening 26 and the viscosity of the fluid. The dissipation and damping characteristic of the impact damper 7 can be adapted to the actual requirements over wide ranges by selecting a fluid with a very high viscosity and/or by making the nozzle opening 26 very small.

A particularly high damping or energy dissipation is achieved by arranging on the side of the nozzle opening 26 that faces away from the primary chamber 24 a jet dispersing element (not shown in the Figures), such as an impact plate. The jet dispersing element prevents the piercing and fast-moving fluid jet flowing at high spring deflection velocities from the primary chamber 24 into the secondary chamber 27 from damaging the elastic secondary chamber component 18 which bounds the secondary chamber 27.

It becomes therefore clear that the invention provides an impact damper for use, in particular, in the area of the wheel suspension of automobiles, which in comparison with conventional dampers advantageously eliminates the divergence between, on one hand, premature buildup of the counter force, a simultaneous reduction in energy over the entire spring deflection and, on the other hand, a high, velocity-dependent dissipation of energy. More particularly, with the impact damper of the invention, for example, peak forces can be effectively controlled and reduced when a wheel suspension bottoms out, which would otherwise damage the wheel suspension or the adjacent chassis components.

The invention therefore represents a significant contribution to the control of the peak forces and to a controlled dissipation of energy, in particular for application of the impact damper in technically demanding, high-quality axle assemblies. With the invention, expensive repairs of connecting components of automobiles can also be eliminated, and/or the weight and costs of corresponding connecting components can be reduced.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

What is claimed is:

1. An impact damper for an automobile comprising
at least one damper unit (8, 9, 10, 11) including at least one elastomer spring element (15),
at least one fluid-filled primary chamber (24), and
at least one fluid-filled secondary chamber (27),
at least one nozzle opening (26) connecting the at least one fluid-filled primary chamber (24) and the at least one fluid-filled secondary chamber two chambers (27), over which nozzle opening (26) the fluid can be displaced during spring deflection of the elastomer spring element (15) from the primary chamber (24) into the secondary chamber (27),
and wherein the damper unit (8, 9, 10, 11) has the shape of an annular body.

2. The impact damper according to claim 1, wherein the damper unit (8, 9, 10, 11) comprises a plurality of primary chambers (24) which are arranged inside the annular body substantially along a circle.

3. The impact damper according to claim 1, wherein the at least one primary chamber (24) is formed substantially by an elastomer spring element (15).

4. The impact damper according to claim 1, wherein the at least one primary chamber (24) comprises a plurality of primary chambers which are formed by a primary chamber component formed as an elastomer spring element (15).

5. The impact damper according to claim 4, wherein the secondary chamber (27) is associated with the plurality of primary chambers (24) of the damper unit (8, 9, 10, 11).

6. The impact damper according to claim 4, wherein the at least one secondary chamber (27) is associated with the plurality of primary chambers (24) of the damper unit (8, 9, 10, 11), wherein the secondary chamber (27) is formed by a substantially annular secondary chamber component (18) made of an elastomer.

7. The impact damper according to claim 1, wherein the nozzle openings (26) of the damper unit (8, 9, 10, 11) are formed by a nozzle plate (19) which is formed substantially as an annular perforated component.

8. The impact damper according to claim 1, further comprising a jet dispersing element, arranged in a region behind each nozzle opening (26) between nozzle opening (26) and secondary chamber (27).

9. The impact damper according to claim 8, wherein the jet dispersing element is formed by a baffle plate.

10. The impact damper according to claim 1, wherein the housing (17) of the damper unit (8, 9, 10, 11) is formed by a one-piece annular body (17) having an open cross-sectional shape.

11. The impact damper according to claim 1, wherein the housing (17) is pressed or rolled with the primary chamber component (15), the nozzle plate (19) and the secondary chamber component (18).

12. The impact damper according to claim 1, wherein the housing (17) is made of a polymer material, wherein the housing (17) is materially connected with the primary chamber component (15) and/or with the nozzle plate (19) and/or with the secondary chamber component (18).

13. The impact damper according to claim 4, wherein the primary chamber component (15) comprises support rings (25) which are vulcanized to or within the primary chamber component (15).

14. The impact damper according to claim 4, wherein the primary chamber component (15) has in the region of an end face of the impact damper (7) a substantially annular connecting element (21) that is vulcanized to or within the end face.

15. The impact damper according to claim 1, wherein the impact damper (7) comprises at least two damper units (8, 9, 10, 11) connected in series, wherein each damper unit (8, 9, 10, 11) comprises the primary chamber (24), secondary chamber (27), nozzle plate (19), and housing (17).

16. The impact damper according to claim 15, wherein the housings (17) of two serially adjacent damper units (8, 9, 10, 11) are formed as a single unit.

17. The impact damper according to claim 15, wherein corresponding pairs of damper units (8, 9, 10, 11) are connected anti-parallel with respect to one another.

18. The impact damper according to claim 1, wherein the impact damper (7) is a McPherson strut impact damper and surrounds the piston of the shock absorber (12) in form of a ring.
